(19) United States
(12) Patent Application Publication
(10) Pub. No.: US 2025/0315679 A1
(43) Pub. Date: Oct. 9, 2025

(54) GENERATIVE COUNTERFACTUAL EXPLANATIONS FROM HUMAN PREFERENCES

(71) Applicant: Dell Products L.P., Round Rock, TX (US)

(72) Inventors: Adriana Bechara Prado, Niterói (BR); Alexander Eulalio Robles Robles, Valinhos (BR); Eduarda Tatiane Caetano Chagas, Belo Horizonte (BR); Helen Cristina de Mattos Senefonte, Londrina (BR); Jonathan Mendes De Almeida, Brasília (BR); Karen Stéfany Martins, Belo Horizonte (BR)

(21) Appl. No.: 18/626,081

(22) Filed: Apr. 3, 2024

(51) Int. Cl. G06N 3/088

(52) U.S. Cl. CPC G06N 3/088

(57) ABSTRACT

One example method includes performing unsupervised training of a multi-modal large language model (MLLM) so as to define an MLU that is able to recognize instances of time series data, performing supervised training of the MLU so as to define an MLS that is able to generate counterfactual explanations (CEs) for anomalies detected in time series data, training a reward large language model (LLM) to evaluate CEs generated by the MLS, and to assign respective scores to the CEs based evaluation of the CEs, and creating a reinforcement learning MLS (RLMLS) model from the MLS, and performing a fine-tuning process using the RLMLS model and the MLS so that, after fine-tuning, the RLMLS is able to generate CEs for different types of anomalous time series instances.

### FIELD OF THE INVENTION

Embodiments of the present invention generally relate to explainable artificial intelligence. More particularly, at least some embodiments of the invention relate to systems, hardware, software, computer-readable media, and methods, for using multimodal large language models to generate counterfactual explanations based on human input. The counterfactual explanations may relate to a prediction generated by a model, such as a prediction as to when a computing system component may fail, for example.

### BACKGROUND

Counterfactual explanations may be used to explain predictions generated by a model, such as a machine learning model for example. More particularly, a counterfactual explanation may explain how a change in an input, or inputs, to the model may change the outcome, that is, a prediction generated by the model. Thus, counterfactual explanations may be useful in assessing performance of the model and for better understanding as to how inputs to the model affect the model predictions. However, counterfactual explanations may be difficult for a human to understand in a meaningful way, particularly if the human is not well-versed in the technology with which the model and counterfactual explanations are concerned.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example method according to one embodiment.

FIG. 2 discloses aspects of an example first phase of the example method disclosed in FIG. 1.

FIG. 3 discloses aspects of an example counterfactual description in the context of a predicted motherboard failure.

FIG. 4 discloses aspects of an example second phase of the example method disclosed in FIG. 1.

FIG. 5 discloses aspects of an example third phase of the example method disclosed in FIG. 1.

FIG. 6 discloses aspects of an example fourth phase of the example method disclosed in FIG. 1.

FIG. 7 discloses an example computing entity configured and operable to perform any of the disclosed methods, processes, and operations.

### DETAILED DESCRIPTION OF SOME EXAMPLE EMBODIMENTS

Embodiments of the present invention generally relate to explainable artificial intelligence. More particularly, at least some embodiments of the invention relate to systems, hardware, software, computer-readable media, and methods, for using multimodal large language models to generate counterfactual explanations based on human input. The counterfactual explanations may relate to a prediction generated by a model, such as a prediction as to when a computing system component may fail, for example.

One example embodiment may comprise a method for generating counterfactual explanations from human preferences. One example of such a method may comprise operations including: training an MLLM (multimodal large language model) using time series data so that the MLLM, when trained, comprises an MLU (machine learning trained in an unsupervised way) that is able to recognize time series instances of data and that is configured for unsupervised training; training the MLU in a supervised mode using anomalies and their respective counterfactual explanations, so that the trained MLU comprises an MLS (machine learning trained in a supervised way); using the MLS to generate, evaluate, and score, CEs (counterfactual explanations) based on inputs that comprise instances of anomalies in a set of time series data; and, fine tuning the MLS using RLHF (reinforcement learning with human feedback) so as to create an RLMLS (reinforcement learning MLS) that is able to generate CEs for various different time series anomaly instances or types by referencing preferences of a human evaluator.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment that counterfactual explanations may be generated that can be readily understood by a human. An embodiment may improve the operation and effectiveness of ML (machine learning) models in their evaluation and explanation of anomalous time series data, and other problems relating to time series data and time series domains. Various other advantages of one or more example embodiments will be apparent from this disclosure.

### A. Supplemental Materials

Following is a list of various documents that may relate to one or more aspects of an example embodiment. These are not intended to limit the scope of the invention in any way. These documents, all of which are incorporated herein in their respective entireties by this reference, and which may be referred to herein by the indicated numbering, include:
[1] Lundberg, Scott M., and Su-In Lee, “A unified approach to interpreting model predictions.” Advances in neural information processing systems 30 (2017).
[2] C. C. M. Yeh et al., “Matrix Profile I: All pairs similarity joins for time series: a unifying view that includes motifs, discords and shapelets”, Proc' of 16th IEEE ICDM, 2016, pp. 1317-22
[3] J. M. DeAlmeida et al., “Abnormal Behavior Detection Based on Traffic Pattern Categorization in Mobile Networks,” IEEE Transactions on Network and Service Management, vol. 18, no. 4, pp. 4213-4224 December 2021, doi: 10.1109/TNSM.2021.3125019.
[4] A. Maske and B. Joglekar, “Survey on Frequent Item-Set Mining Approaches in Market Basket Analysis,” in 2018 Fourth International Conference on Computing Communication Control and Automation (ICCUBEA), August 2018, pp. 1-5. doi: 10.1109/ICCUBEA.2018.8697776.
[5] Ribeiro, M. T., Singh, S., & Guestrin, C., “Why Should I Trust You?” Explaining the Predictions of Any Classifier. In Proceedings of the 22nd ACM SIGKDD International Conference on Knowledge Discovery and Data Mining (KDD'16), pp. 1135-1144, 2016.
[6] SULEM, Deborah et al., Diverse Counterfactual Explanations for Anomaly Detection in Time Series. arXiv preprint arXiv: 2203.11103, 2022.
[7] OpenAI, “Introducing ChatGPT”, Open AI Blog, 2022.
[8] Platen, P. V., “Optimizing your LLM in production”, HuggingFace Blog, 2023.
[9] Pangu, E., Google's Latest Approaches to Multimodal Foundational Model, Towards Data Science Blog, 2023.
[10] HuggingFace, “Illustrating Reinforcement Learning from Human Feedback (RLHF)”, HuggingFace Blog, 2022.
[11] Sutton, R. S., & Barto, A. G., Reinforcement Learning: An Introduction. MIT Press, 1998.
[12] Watkins, C. J., “Learning from Delayed Rewards.” Research Notes in Artificial Intelligence, 1989.
[13] Christiano, Paul F., et al., “Deep reinforcement learning from human preferences.” Advances in neural information processing systems 30, 2017.
[14] HAO, Yaru, et al., Language models are general-purpose interfaces. arXiv preprint arXiv: 2206.06336, 2022.
[15] ALAYRAC, Jean-Baptiste, et al., Flamingo: a visual language model for few-shot learning. Advances in Neural Information Processing Systems, 2022, vol. 35, p. 23716-23736.
[16] HU, Edward J., et al., Lora: Low-rank adaptation of large language models. arXiv preprint arXiv: 2106.09685, 2021.
[17] DETTMERS, Tim, et al., Qlora: Efficient finetuning of quantized Ilms. arXiv preprint arXiv: 2305.14314, 2023.
[18] SCHULMAN, John, et al. Proximal policy optimization algorithms. arXiv preprint arXiv: 1707.06347, 2017.

### B. Aspects of a Context for an Example Embodiment

Below, an overview is presented of various concepts related to an example embodiment. Such concepts may include, for example, XAI, CE, MLLM, and RLHF.

### B.1 Explainable AI (XAI)

XAI techniques may generally belong to one of two broad families, namely, model-agnostic methods, and interpretable models. Model-agnostic methods separate explanations from the Machine Learning (ML) model and provide feature-based explanations, generally based on data perturbation.

More specifically, the explanations are provided in terms of feature importance scores that indicate how much each feature contributes to the prediction generated by the model. Conversely, interpretable models, such as generalized linear models, generate trackable information regarding how the model achieves a particular result, for example, the trained parameters of a Poisson regression. In particular, the parameters of a regression or the outlier score value computed by the model such as, for example, distances computed by matrix profile, reconstruction error computed by Autoencoder solutions, and energy computed by quantum mechanics approaches.

In general, there are two categories of XAI techniques, namely, post-hoc, and non-post-hoc, techniques. Post-hoc techniques may be applied after an ML model has made its predictions or decisions. Non-post-hoc techniques, on the other hand, may serve to build interpretability into the model itself during training or model development.

### B.2 Counterfactual Explanations (CEs)

Characterized as post-hoc techniques, counterfactual explanations are provided in the form of synthetic samples, which consist of the smallest set of changes in the features values that change the predefined output label. Counterfactual samples may have four important characteristics that contribute to obtaining an actionable explanation: (1) Validity—the label of the predicted class will be changed; (2) Parsimony—the synthetic samples produced will be examples with minimal changes in relation to the original input; (3) plausibility—the synthetic samples need to be realistic examples for the domain in question; and (4) being computable within a reasonable amount of time and/or use of a reasonable amount of computing resources.

### B.3 Multimodal Large Language Model (MLLM)

At least as used herein, a Large Language Model (LLM) comprises a deep learning model that can recognize, summarize, translate, predict, and generate text and other forms of content based on knowledge gained from massive datasets. Multimodal large language models (MLLMs) are LLMs capable of combining different types of information, such as text, images, videos, audio, and sensory data and generate human-like language. Language is used for more than human communication. For example, code is the language of computers, and protein and molecular sequences are the language of biology.

MLLMs may be applied to such languages or scenarios in which communication of different types is needed. These models have the potential to enable a new wave of research, creativity, and productivity, as they can help to generate complex solutions for difficult problems. LLMs represent a significant advancement in natural language processing (NLP) and have a wide range of applications. MLLMs are unlocking new possibilities in areas such as search engines, healthcare, robotics, and code generation. The ChatGPT AI chatbot is only one application of a large language model.

B.4 Reinforcement Learning with Human Feedback (RLHF)

The success of ChatGPT raises the discussion about relevant techniques used to optimize ML models. Reinforcement learning with human feedback (RLHF) makes it possible for language models (LMs) to map complex human values to a general corpus of text data and may be helpful in enabling the current generation of advanced LLM chatbots.

RLHF is based on the technique of Reinforcement Learning (RL). In this type of machine learning, the agent interacts with an environment and receives feedback in the form of rewards or penalties based on its actions. During the first stage of training in RL, the agent takes random actions in the environment. Data are gathered and stored as experiences to train the policy, that is, a mapping from states to actions. Once a minimum amount of experiences is collected, from the agent interaction with the environment, the RL algorithm may be run in order to update the policy. There are different ways to represent the policy, for example by using the Q-learning algorithm, the policy is represented as a state-action matrix, mapping all possible actions for each state. In the Deep Q-Network algorithm, the policy is represented as a neural network that can estimate the value of each action considering a given state. The goal of the agent is to learn a policy that maximizes the expected cumulative reward over the time.

### C. Overview of Aspects of an Example Embodiment

One example embodiment may comprise the use of an MLLM to generate use-case-oriented counterfactual explanations from human preferences. An example embodiment may comprise four main phases:

Phase 1—In this phase, an MLLM may be trained in an unsupervised way using a training dataset that may comprise a huge quantity of time series examples. Data for the training dataset may be obtained from one or more internet open sources. This data may be cleaned to be more accurate, and the available descriptions of the time series, such as documentation of the time series or detailed description that describes the features and nature of the time series, may also added to, or otherwise associated with, the training dataset. After the cleaning step, the cleaned data may be transformed into a, most appropriate, embedding representation that is ready for the unsupervised training step, the next phase in this example embodiment. This trained MLM, which may be used in the next phase, may be referred to herein as an MLU.

Phase 2—considering the problem of anomaly detection, in this phase, the MLU model obtained in the previous phase may be trained in a supervised way, to understand anomalies from time series instances, and those anomalies with via CEs. The data, which may comprise time series instances and their corresponding CEs, may be labeled by human subject matter experts (SMEs). The trained MLU may be referred to herein as an MLS.

Phase 3—in this phase, the MLS may generate several CEs from inputs that take the form of anomalous time series instances. In this phase, those CEs may be ranked by SMEs, based on human preferences, according to a scalar reward, that is, a score may be given by an SME to each explanation. Both CE and corresponding score, which may be expressed in the format {CE sample, rewards}, may then be used to train another LLM, either fine-tuning a trained LLM or training an LLM from scratch, that is not as large, in terms of its parameters, as the MLLM employed in phase 1. This additional LLM may be focused on learning how to assign a score to generated CEs, based on human preferences for a specific domain. This additional LLM may be referred to herein as a Reward LLM.

Phase 4—in an embodiment, the example method may be closed by using a Reinforcement Learning (RL) technique. To briefly summarize some aspects of one example method according to an embodiment, the following models may be built in the various phases of this embodiment:
The MLU (phase 1)—the MLLM may be trained in an unsupervised manner;
The MLS (phase 2)—the MLU may be trained in a supervised way to understand anomalies and their respective CEs; and
The Reward LLM (phase 3)—the Reward LLM may be trained in a supervised way to assign a score for MLS response.

In this final Phase 4 of an embodiment, another model may be created, which may comprise a copy of MLS referred to herein as an RLMLS, and both the MLS and the RMLS may be employed in the final loop of training by using the most appropriate RL.

The time series with anomalies may then be passed as inputs to both the MLS and the RLMLS. Then, the respective output explanations, that is, the CEs, generated by the two models, may be compared by using any technique that measures divergence between sequence of distributions. One example embodiment may use the Kullback-Leibler divergence between their sequence of distributions over tokens. The Reward LLM may then be combined with a constraint on the policy shift and act as a reward function. Following that, the weights, that is, only portions of the entire models, of the RLMLS may be updated by using a process such as Proximal Policy Optimization (PPO).

After this final training operation, the RLMLS may be operable to generate trustfulness CEs that follow human preferences, as expressed by the rankings generated by one or more SMEs. In an embodiment, these CEs may be relatively rich in terms of their content, and users that are not experts in the applicable technical field to which the time series data relates should be able to understand the explanations.

### D. Further Discussion

As will be apparent from this disclosure, example embodiments may possess one or more useful aspects and advantages. However, no embodiment is required to possess any of such aspects or advantages. The following examples are illustrative.

An example embodiment may develop and use a Multimodal LLM that can generate counterfactual explanations (CEs) for time series problems, such as anomaly detection for example, that are readily understood by a human, and particularly a human not familiar or well-versed in the technology to which the time series data relates. An embodiment may employ human preferences, and an embodiment may employ CEs ranked by subject matter experts (SMEs) that will give a score for each generated explanation. This annotated data may then be used for training a reward model. An embodiment may comprise a complete training process that may be applied to any other time series domains. An embodiment may produce CEs that are human-readable and understandable by non-expert users and, particularly, a model may generate CEs that are rich in content, so that non-expert users in the field can understand the explanations. As a final example, an embodiment may help to preserve MLLM creativity. That is, an embodiment may help to preserve the creativity of the MLLM by adding its original output in the final training loop. This approach may enable a greater range of variations that may contain rich information that may enhance the CEs.

### E. Detailed Discussion of Aspects of an Example Embodiment

### E.1 Introduction

The generation of Counterfactual Explanations (CEs) is a growing field in the Explainable Artificial Intelligence (XAI) area. A counterfactual explanation describes the smallest change to the feature values that can translate to a different output label. The CE of a prediction may have the advantage of being more human-readable and must satisfy the properties typical of counterfactuals, such as plausibility. For example, a desirable counterfactual should never change preset immutable features such as gender, or race.

Multimodal Large Language Models (MLLMs) have recently surpassed the capacity of Large Language Models (LLMs), which are text-only and have limited ability to understand other types of data. In contrast with LLMs, MLLMs can process and interact with other types of data such as images, videos, audio, and sensory inputs, along with the text.

In an embodiment, an MLLM may be trained, modified, and/or created, that may generate human-readable CEs for time series related problems, such as anomaly detection in time series data. These CEs may be enhanced, in terms of quality and trustfulness, based on human preferences, that is, with a human in model training loop. An embodiment may comprise a complete process for training an MLLM for adapting the MLLM to a specific time series domain. An embodiment comprises a training process for MLLMs so that an MLLM trained using that training process may be able to generate CEs for their specific use cases by enhancing the quality of outputs with human preferences.

### E.2 Discussion

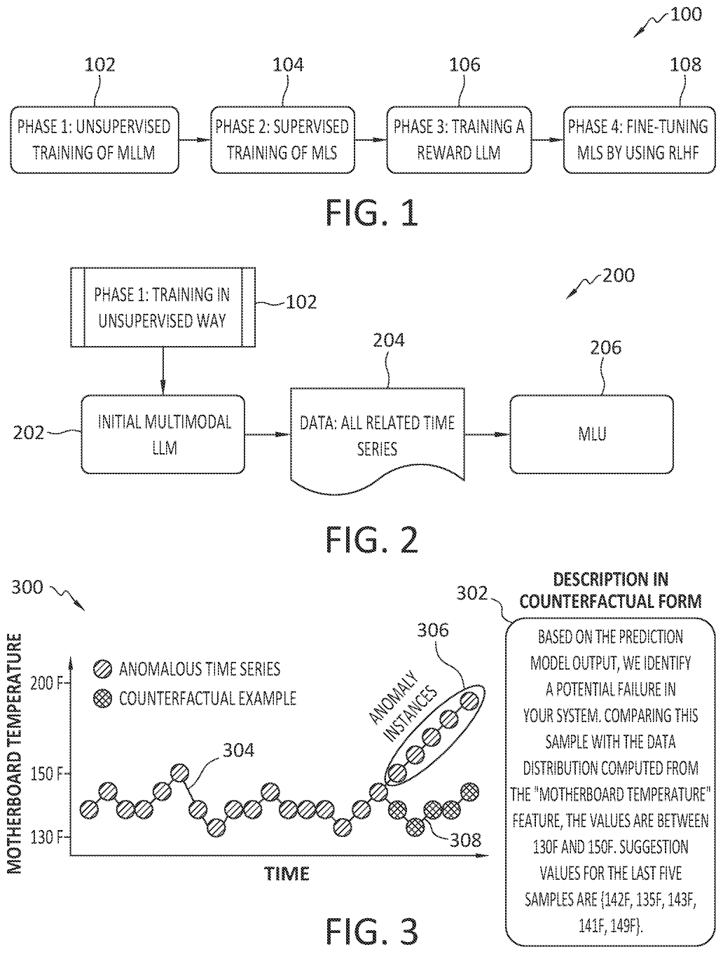

In an embodiment, a multimodal large language model (MLLM) is trained and used that may provide counterfactual explanations, enhanced by human preferences, of anomalies in time series data. FIG. 1 discloses an overview of a method 100, according to one embodiment, that may comprise four phases, namely, Phase 1 (unsupervised training of an MLLM), Phase 2 (supervised training of an MLS), Phase 3 (training of a Reward LLM), and Phase 4 (fine-tuning a trained MLS using an RLHF technique).

### E.2.1 Phase 1

In this Phase 1, denoted at 102, a pre-trained MLLM may be selected that was trained on multimodal data which may comprise, for example, images, audio, and text. For this specific domain, an embodiment may adapt this pre-trained MLLM to enable the MLLM to perceive, and understand, time series instances. One embodiment may involve training the MLLM on web-scale multimodal data that includes text and images regarding time series images caption and their documentation in text form.

In an embodiment, the training data for further training of the MLLM may be prepared by collecting all the available sources from the web, such as open-source time series data, public GitHub repositories with license that permits to use them for training, arXiv papers and any/all the public information on the internet related to the particular domain of interest. At this stage, that is, in Phase 1, the sort of time series may not be a matter of concern. An embodiment may collect the most accurate data for the domain of interest, and that data may comprise, for example, time series timesteps, images such as plots from time series data with their corresponding description and caption. This data need not be obtained from any particular sources but may, in an embodiment, be obtained from domains of interest such as, but not limited to, economics, computing systems and devices, transportation industry applications, telemetry from servers, foods, and energy industries.

In an embodiment, the selected MLLM may be trained in an unsupervised manner. Prior to this training, a sequence of input data, that is, data that is to be used for the unsupervised training of the MLLM, may be annotated with tokens. For example, the <s> tag and </s> may be used to respectively denotate the start and end-of-sequence of the input data. The tag <image> and </image> may be used to point out the start and end of encoded image. For instance: “<s> documentation of time series</s>” is a text input, and “<s> paragraph description <image> Image of Time Series </image>” is a pair of image-text input.

In an embodiment, all of the training data may be encoded into vector embeddings. In an embodiment, the disclosure of may be used to leverage a vision encoder and in the resample part [16], the number of image embeddings may be reduced by applying an attentive pooling mechanism. After training of the MLLM with this training data, the MLLM may then be able to perceive, or recognize, time series instances. To validate these new capabilities of the MLLLM, an embodiment may evaluate the MLLM in several scenarios such as, but not limited to, zero-shot, few-shot, and multimodal chain-of-thought prompting.

With the foregoing discussion in view, attention is directed to FIG. 2 which discloses a specific example implementation 200 of the Phase 1 102 shown in FIG. 1. In particular, FIG. 2 discloses that the input to the MLLM training process may comprise the MLLM itself, which may be fed with time series data 204 of various types and/or domains. After the unsupervised training of the MLLM, using the time series data 204, the output of the process shown in FIG. 2 is referred to herein as an MLU 206 model, that is, the MLLM that was trained in an unsupervised manner using the time series data 204.

### E.2.2 Phase 2

In this Phase 2, the model from Phase 1 referred to as the MLU may be trained in a supervised mode for anomaly detection in a time series domain. In an embodiment, each element from the training dataset that will be used to train the MLU may comprise the following structure: {Anomaly instances, Description in Counterfactual form}. In an embodiment, the descriptions—in counterfactual form—of the anomaly instances may be prepared by human SMEs (subject matter experts). This prepared data, that is, the training data, may be referred to as labeled data, which may generally be employed in supervised training processes. The labeling of the anomaly instances may require an SME to describe the anomaly and also explain which features from the time series instances are impacted and involved in this event. One example of a counterfactual description is generally indicated at 300 in FIG. 3.

The particular example of FIG. 3 concerns a domain in which motherboard failures are identified and described. The particular counterfactual description, which may have been generated by an SME, is denoted at 302, and the anomalous instances, taking the form of a motherboard temperature spike in this example, of the time series data 304 are denoted at 306. Reference 308 denotes a counterfactual example.

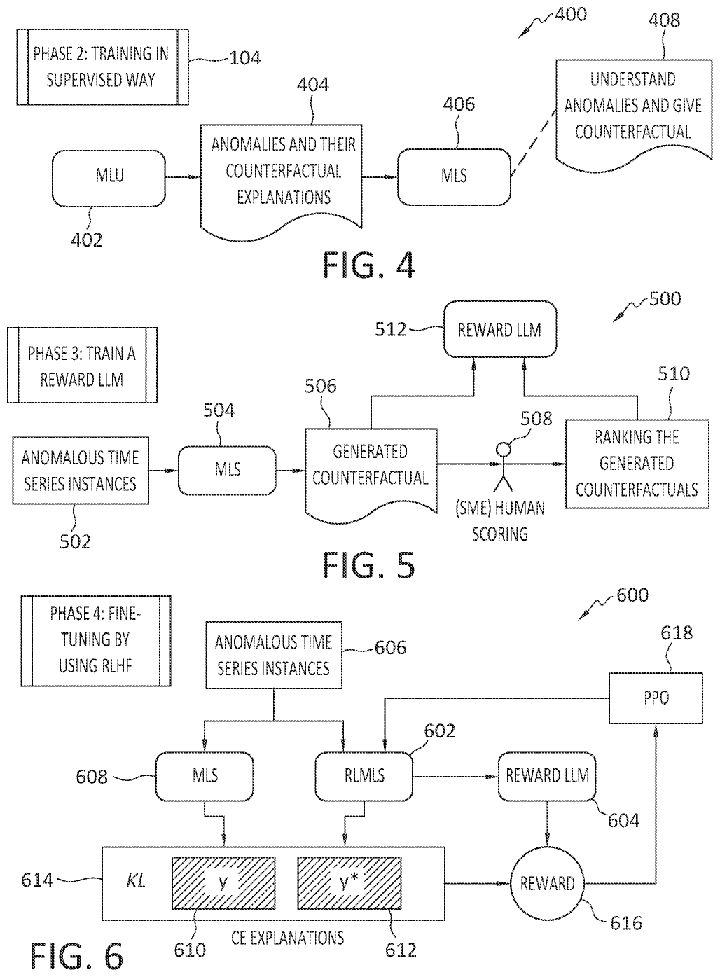

With the foregoing discussion in view, attention is directed to FIG. 4 which discloses a specific example implementation 400 of the Phase 2 104 shown in FIG. 1. In particular, FIG. 4 discloses that the input comprises an MLU model 402, or simply MLU, such as the MLU model 206 generated in the process of FIG. 2, and the output, after supervised training of the MLU 402 using input data 404 comprising anomalies and their respective CEs, comprises the MLS 406. Thus trained, the MLS 406 may be able to recognize and understand the anomalies, and generate respective counterfactuals for those anomalies, as shown at 408.

In an embodiment, instead of training the entire MLU 402, which may comprise billions of parameters, techniques for fine-tuning may be applied, such as those techniques disclosed in and [18], to avoid the need for high computing resource requirements, and the associated costs. In an embodiment, such techniques may significantly reduce the number of parameters, relative to the number of parameters in the entire MLU 402, that may be estimated during training.

### E.2.3 Phase 3

In this Phase 3 of an example embodiment, the model MLS obtained in Phase 2 may operate to produce several counterfactual explanations from anomalous time series data instances. The MLS may be able to recognize the anomalies in the time series data and then generate respective counterfactual explanations for those anomalies, since the MLS was trained in Phase 2 to perform that task. In an embodiment, the next operation after generation of these CEs will be for the SMEs to rank the MLS-generated CEs using two sets of metrics, namely, human preference, and formulas. The formulas may be employed to measure counterfactual qualities such as, for example, failure rate, time series distance between the input sample and the counterfactuals, and temporal smoothness.

With the foregoing discussion in view, attention is directed to FIG. 5 which discloses a specific example implementation 500 of the Phase 3 106 shown in FIG. 1. In particular, FIG. 5 discloses the use of human annotators, or SMEs, to rank the CEs generated by the MLS. As indicated in the example implementation 500 of a Phase 3 in FIG. 5, information 502 identifying anomalous time series instances may be provided as input to an MLS 504. The MLS 504 may then generate CEs 506 based on the input 502. The CEs 506 may be ranked, possibly numerically, by a human SME 508, to generate a ranked list 510 of CEs.

As further indicated in the example of FIG. 5, the generated CEs 506 and the rankings 510 may be provided as inputs for the training of a Reward LLM 512. In an embodiment, the Reward LLM 512 may use these inputs to learn to evaluate the CE output from the MLS 504, and assign a respective numeric score to one or more of those CEs. In an embodiment, the Reward LLM 512 is an another LLM with a relatively smaller number of parameters that can be specialized for its tasks and, as such, the Reward LLM 512 may be relatively shallower, that is, may have fewer parameters, than the MLS 504. At the completion of its training, the Reward LLM 512 may be able to close the RLHF loop in the final phase, as discussed below.

### E.2.4 Phase 4

In this Phase 4 of an example embodiment, a new model may be created from MLS, and may be referred to herein as RLMLS. Both models, that is, the MLS and RLMLS, may be included in the final loop of fine-tuning by applying an approach such as Proximal Policy Optimization (PPO). In an embodiment, only a few layers, or only one layer, of the RLMLS model will be fine-tuned, instead of training the whole model, which may comprise many layers.

In an embodiment, this fine-tuning may be initialized by inputting time series anomalies to both models, that is, the MLS and the RLMLS. Then, the respective outputs from each of these models, which may comprise various CEs, may be compared to each other by using the Kullback-Leibler (KL) divergence between their sequence of distributions over the total tokens. The KL divergence term penalizes the RLMLS policy from moving substantially away from the initial pretrained model, that is, the MLS, with each training batch, which can be useful to make sure the model outputs reasonably coherent text snippets.

To follow the human preference, discussed earlier herein, the output of RLMLS may be evaluated by the Reward LLM, obtained in Phase 3, that gives a numeric score for each CE. The score and the KL divergence are both merged to be used in a PPO process. In an embodiment, the RLMLS is defined as policy in the loop and a shallow part of the RLMLS may be updated in one or more of the loops of the training process. This training process may run for any number of epochs.

The combination of scores in the loop process involving the MLS and RLMLS enables an embodiment to follow the human preference for one or more particular CEs that should increase the quality of the CE explanations. The divergence of both outputs may preserve the creativity aspect of multimodal LLM, so this fine-tuning technique may be set up for equilibrium.

Finally, the fine-tuned RLMLS may be able to generate CE explanations from several kinds of anomalous time series instances by following the preferences of human evaluators, that is, the SMEs. The final model may be included in real-time system monitoring to catch up the anomalies and it can provide a complete report that contains the CE explanations for better understanding the causes of the anomalies.

With the foregoing discussion in view, attention is directed to FIG. 6 which discloses a specific example implementation 600 of the Phase 4 108 shown in FIG. 1. In particular, FIG. 6 discloses an RLMLS model 602 fine-tuned by using RLHF. In this loop, the Reward LLM 604 previously created at Phase 3 evaluates the response of RLMLS 602.

In more detail, anomalous time series instances 606 may be input to both the MLS 608 and the RLMLS 602. The MLS 608 and RLMLS 602 may each use the anomalous time series instances 606 as a basis to generate respective sets of CEs 610 and 612. The CEs 610 and 612 may be compared with each other, using the KL divergence approach 614. The divergence may be merged at 616 with CE scores output by the Reward LLM 604, and this information passed to the PPO 618 for optimization of the weights of the RLMLS 602 and the output of the PPO 618 then returned to the RLMLS 602. In an embodiment, and so as to accord with preferences expressed by the SMEs, the output of the RLMLS 602 may be provided to the Reward LLM 604 for evaluation and assignment of scores for the CEs. The output CE scores of the Reward LLM 604 may then be merged 616 with the divergence generated by the KL divergence approach 614, as noted earlier.

### F. Example Methods

It is noted with respect to the disclosed methods, including the example method of FIGS. 1-6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. Further Example Embodiments

Following are some further example embodiments of the invention. These are presented only by way of example and are not intended to limit the scope of the invention in any way.

Embodiment 1. A method, comprising: performing unsupervised training of a multi-modal large language model (MLLM) so as to define an MLU that is able to recognize instances of time series data; performing supervised training of the MLU so as to define an MLS that is able to generate counterfactual explanations (CEs) for anomalies detected in time series data; training a reward large language model (LLM) to evaluate CEs generated by the MLS, and to assign respective scores to the CEs based evaluation of the CEs; and creating a reinforcement learning MLS (RLMLS) model from the MLS, and performing a fine-tuning process using the RLMLS model and the MLS so that, after fine-tuning, the RLMLS is able to generate CEs for different types of anomalous time series instances.

Embodiment 2. The method as recited in any preceding embodiment, wherein, prior to the unsupervised training, the MLLM was trained with multi-modal data.

Embodiment 3. The method as recited in any preceding embodiment, wherein the unsupervised training is performed using multi-modal time-series data comprising text and images.

Embodiment 4. The method as recited in any preceding embodiment, wherein the supervised training is performed using a dataset that comprises multiple elements, each of which has a form {anomaly instance, description in counterfactual form}.

Embodiment 5. The method as recited in embodiment 4, wherein the description in counterfactual form is generated by a human.

Embodiment 6. The method as recited in any preceding embodiment, wherein the scores, together with one or more formulas, enable a human subject matter expert (SME) to rank the CEs generated by the MLS.

Embodiment 7. The method as recited in any preceding embodiment, wherein the reward LLM has fewer parameters than the MLS.

Embodiment 8. The method as recited in any preceding embodiment, wherein training the reward LLM is performed using numerical rankings of the CEs that were generated by the MLS.

Embodiment 9. The method as recited in any preceding embodiment, wherein the fine-tuning comprises: inputting a common group of time series anomalies to both the MLS and the RLMLS; comparing respective CE outputs of the MLS and the RLMLS to identify divergences between the CE outputs of the MLS and the CE outputs of the RLMLS; merging the divergences with scores of the CE outputs to form a merged output; providing the merged output to a proximal policy optimization (PPO) process; and with the PPO process, using the merged output to fine tune the RLMLS.

Embodiment 10. The method as recited in any preceding embodiment, further comprising: receiving, by the RLMLS, a set of time-series data that comprises one or more anomalies; and generating, by the RLMLS, a respective CE for one or more of the anomalies in the set of time-series data, and the CEs are comprehensible by a human.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

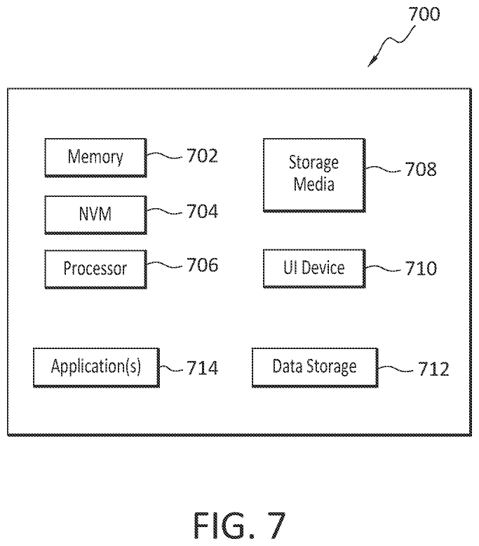

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random-access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
performing unsupervised training of a multi-modal large language model (MLLM) so as to define an MLU that is able to recognize instances of time series data;
performing supervised training of the MLU so as to define an MLS that is able to generate counterfactual explanations (CEs) for anomalies detected in time series data;
training a reward large language model (LLM) to evaluate CEs generated by the MLS, and to designate respective scores (assigned by human subject matter experts) to the CEs based on the evaluation of the CEs; and
creating a reinforcement learning MLS (RLMLS) model from the MLS, and performing a fine-tuning process using the RLMLS model and the MLS so that, after fine-tuning, the RLMLS is able to generate CEs for different types of anomalous time series instances.

2. The method as recited in claim 1, wherein, prior to the unsupervised training, the MLLM was trained with multi-modal data.

3. The method as recited in claim 1, wherein the unsupervised training is performed using multi-modal time-series data comprising text and images.

4. The method as recited in claim 1, wherein the supervised training is performed using a dataset that comprises multiple elements, each of which has a form {anomaly instance, description in counterfactual form}.

5. The method as recited in claim 4, wherein the description in counterfactual form is generated by a human.

6. The method as recited in claim 1, wherein the scores, together with one or more formulas, enable a human subject matter expert (SME) to rank the CEs generated by the MLS.

7. The method as recited in claim 1, wherein the reward LLM has fewer parameters than the MLS.

8. The method as recited in claim 1, wherein training the reward LLM is performed using numerical rankings of the CEs that were generated by the MLS.

9. The method as recited in claim 1, wherein the fine-tuning comprises:
inputting a common group of time series anomalies to both the MLS and the RLMLS;
comparing respective CE outputs of the MLS and the RLMLS to identify divergences between the CE outputs of the MLS and the CE outputs of the RLMLS;
merging the divergences with scores of the CE outputs to form a merged output;
providing the merged output to a proximal policy optimization (PPO) process; and
with the PPO process, using the merged output to fine tune the RLMLS.

10. The method as recited in claim 1, further comprising:
receiving, by the RLMLS, a set of time-series data that comprises one or more anomalies; and
generating, by the RLMLS, a respective CE for one or more of the anomalies in the set of time-series data, and the CEs are comprehensible by a human.

11. A non-transitory storage medium having stored therein instructions that are executable by one or more hardware processors to perform operations comprising:
performing unsupervised training of a multi-modal large language model (MLLM) so as to define an MLU that is able to recognize instances of time series data;
performing supervised training of the MLU so as to define an MLS that is able to generate counterfactual explanations (CEs) for anomalies detected in time series data;
training a reward large language model (LLM) to evaluate CEs generated by the MLS, and to designate respective scores (assigned by human subject matter experts) to the CEs based on the evaluation of the CEs; and
creating a reinforcement learning MLS (RLMLS) model from the MLS, and performing a fine-tuning process using the RLMLS model and the MLS so that, after fine-tuning, the RLMLS is able to generate CEs for different types of anomalous time series instances.

12. The non-transitory storage medium as recited in claim 11, wherein, prior to the unsupervised training, the MLLM was trained with multi-modal data.

13. The non-transitory storage medium as recited in claim 11, wherein the unsupervised training is performed using multi-modal time-series data comprising text and images.

14. The non-transitory storage medium as recited in claim 11, wherein the supervised training is performed using a dataset that comprises multiple elements, each of which has a form {anomaly instance, description in counterfactual form}.

15. The non-transitory storage medium as recited in claim 14, wherein the description in counterfactual form is generated by a human.

16. The non-transitory storage medium as recited in claim 11, wherein the scores, together with one or more formulas, enable a human subject matter expert (SME) to rank the CEs generated by the MLS.

17. The non-transitory storage medium as recited in claim 11, wherein the reward LLM has fewer parameters than the MLS.

18. The non-transitory storage medium as recited in claim 11, wherein training the reward LLM is performed using numerical rankings of the CEs that were generated by the MLS.

19. The non-transitory storage medium as recited in claim 11, wherein the fine-tuning comprises:
inputting a common group of time series anomalies to both the MLS and the RLMLS;
comparing respective CE outputs of the MLS and the RLMLS to identify divergences between the CE outputs of the MLS and the CE outputs of the RLMLS;
merging the divergences with scores of the CE outputs to form a merged output;
providing the merged output to a proximal policy optimization (PPO) process; and
with the PPO process, using the merged output to fine tune the RLMLS.

20. The non-transitory storage medium as recited in claim 11, further comprising:
receiving, by the RLMLS, a set of time-series data that comprises one or more anomalies; and
generating, by the RLMLS, a respective CE for one or more of the anomalies in the set of time-series data, and the CEs are comprehensible by a human.
